(19) United States
(12) Patent Application Publication
(10) Pub. No.: US 2024/0344502 A1
(43) Pub. Date: Oct. 17, 2024

(54) FLOATING OFFSHORE PLATFORM FOR CONVERTING WIND ENERGY INTO ELECTRICITY

(71) Applicant: ITALIAN WIND TECHNOLOGIES SOCIETÀ A RESPONSABILITÀ LIMITATA, Altamura (BA) (IT)

(72) Inventor: Giuseppe GRAUSO, Altamura (BA) (IT)

(21) Appl. No.: 18/291,537

(22) PCT Filed: May 17, 2022
(86) PCT No.: PCT/IT2022/050130

§ 371 Date: Jan. 23, 2024

(30) Foreign Application Priority Data
Aug. 4, 2021 (IT) 102021000021116

(51) Int. Cl. F03D 13/25; F03D 9/00

(52) U.S. Cl. CPC F03D 13/256; F03D 9/007; F05B 2220/708; F05B 2240/212; F05B 2240/95

(57) ABSTRACT

This relates to a floating offshore platform for converting wind energy into electricity through a wind turbine with a vertical axis of the Darrieus type, and for converting solar energy into electricity though a plurality of photovoltaic modules which also provide the electricity required to start the turbine.

### FIELD OF APPLICATION OF THE INVENTION

The present invention applies to the field of turbines (also referred to as “tur-bomachinery”), i.e., to the field of fluid turbine machinery adapted to convert the kinetic and/or pressure energy of a fluid into mechanical energy (such as into the rotation of a drive shaft about its axis, for example).

The present invention particularly relates to the so-called “wind” turbines, i.e., turbines adapted to convert a movement of masses of atmospheric air into mechanical energy (i.e., atmospheric air currents or “winds”). Wind turbines are generally connected, by means of a transmission shaft, to an alternator to convert the mechanical energy, into which said turbines convert wind energy, into electricity.

The present invention more precisely relates to a wind turbine installed on a so-called “offshore” platform, i.e., a platform intended to be placed in the open sea, of the floating type.

### OVERVIEW OF THE PRIOR ART

Current wind turbines installed on offshore platforms are turbines with a horizontal axis, i.e., turbines provided with blades which are rotatable by the wind about an axis arranged horizontally. As known, said turbines are capable of converting wind energy into mechanical energy only if the rotor is oriented in the direction in which the wind blows. In order for a wind turbine with a horizontal axis to always operate in the presence of wind, it is thus necessary to keep the rotor oriented in the direction of the wind corrections. In the open sea, however, the winds repeatedly change direction. In order for a wind turbine with a horizontal axis installed on an offshore platform to always operate in the presence of wind, it is thus necessary to rotate the rotor repeatedly to keep it oriented in the direction of the wind currents.

### OBJECTS OF THE INVENTION

It is the object of the present invention to overcome the aforesaid drawbacks by indicating an offshore platform including at least one wind turbine adapted to convert wind energy into mechanical energy regardless of the direction in which the wind blows.

### SUMMARY AND ADVANTAGES OF THE INVENTION

The present invention relates to an offshore platform comprising:
a base at which said platform is placeable in the sea;
at least one wind turbine supported by said base, said turbine including a rotor which is rotatable about a rotation axis, said turbine being adapted to convert at least partially wind energy into mechanical energy, and more precisely into a rotation of said rotor about said rotation axis;
at least one alternator connected to said rotor and adapted to convert a rotation of said rotor about said rotation axis into electricity;
electricity transmission means connected to said alternator and adapted to transfer electricity out of said platform, wherein said alternator is adapted to convert a rotation of said rotor about said axis,

when said platform is placed in the sea at said base, said platform being adapted to float so that said turbine lies at least partially out of the sea, in which, in accordance with the invention, said turbine is of the “vertical axis” type,

said turbine being supported by said base so that, when said platform is placed in the sea at said base, assuming that the free surface of the sea is flat and arranged horizontally, said rotation axis about which said rotor is rotatable is arranged vertically.

Advantageously, a turbine with a vertical axis, unlike a turbine with a horizontal axis, is adapted to convert wind energy into mechanical energy regardless of the direction in which the wind blows. The turbine of the platform of the invention is thus capable of “accepting” the wind regardless of the direction in which it blows. In addition, said turbine, unlike the wind turbines with a horizontal axis, does not require yaw angle control mechanisms, nor a speed multiplier. A smaller number of moving parts advantageously results in more limited wear phenomena as compared to wind turbines with a horizontal axis.

Other innovative features of the present invention are disclosed in the following description and mentioned in the dependent claims.

According to an aspect of the invention, said turbine is of the “Darrieus” type,

said rotor comprising a plurality of blades which are connected to a transmission shaft and rotatable, together with said shaft, about said rotation axis,

said turbine being adapted to convert at least partially wind energy into a rotation of said blades and said shaft about said rotation axis,

said shaft including a first end and a second end opposite said first end,

said turbine being supported by said base so that said first end is closer to said base than said second end,

said shaft being connected to said alternator at said first end,

said shaft being connected to said alternator so that said alternator is adapted to convert a rotation of said shaft about said rotation axis into electricity,

said platform further comprising:
storage means adapted to store electricity,
   said storage means being connected to said alternator for storing electricity, wherein said alternator is adapted to convert a rotation of said shaft about said rotation axis;
   rotation means connected to said shaft and adapted to rotate the latter about
   said rotation axis,
   said rotation means being electrically powerable,
   said storage means being connected to said rotation means for powering the latter by means of electricity stored in said storage means.

Incidentally, the presence of the storage means, such as an electric accumulator, for example, and of the rotation means, such as an electric motor, for example, is necessary since the turbines of the Darrieus type, as known, are not self-starting. By means of the electric motor, the rotor is set in rotation at an in-creasing angular speed, until a limit speed is reached such as to allow the turbine to operate autonomously.

According to this aspect of the invention, the alternator is close to the base. Therefore, the platform of the invention has a center of gravity which is advantageously lower as compared to current offshore platforms which include wind turbines with a horizontal axis. A lower center of gravity results in a greater stability of the platform when in the sea. Since the alternator is close to the base, it is also more easily accessible, and thus maintainable, than the alternators of the current offshore platforms for converting wind energy into electricity.

According to another aspect of the invention, said storage means and said rotation means are closer to said base than said second end.

According to this aspect of the invention, the electric accumulator and the electric motor, like the alternator, are close to the base. Therefore, they advantageously contribute to giving greater stability to the platform when in the sea and are easily accessible.

According to another aspect of the invention, said base comprises an upper wall,

when said platform is placed in the sea at said base, said platform being adapted to float so that said upper wall lies at least partially out of the sea,

said platform comprising one or more photovoltaic modules (each of which comprising multiple photovoltaic cells) at said upper wall, so as to be adapted to convert solar energy into electricity when said platform is placed in the sea at said base,

said transmission means being connected to said one or more photovoltaic modules and being adapted to transfer electricity out of said platform, wherein said one or more photovoltaic modules are adapted to convert solar energy.

Advantageously, according to this aspect of the invention, the offshore platform is capable of dispensing electricity by converting it not only from wind energy but also from solar energy.

According to another aspect of the invention, said one or more photovoltaic modules are connected to said rotation means for powering the latter.

Advantageously, according to this aspect of the invention, photovoltaic modules can dispense the electricity needed to start the turbine.

According to another aspect of the invention, said storage means are connected to said one or more photovoltaic modules for storing electricity, wherein said one or more photovoltaic modules are adapted to convert solar energy.

According to another aspect of the invention, said one or more photovoltaic modules are connected to said rotation means not directly, but only through said storage means.

According to another aspect of the invention, the electricity produced in excess of the capacity of the storage means is transferred directly out of the platform.

According to another aspect of the invention, said transmission means are connected to said storage means and are adapted to transmit the electricity stored in said storage means out of said platform.

According to another aspect of the invention, said transmission means are connected to said alternator not directly, but only through said storage means.

According to an aspect of the invention, said platform comprises mooring means adapted to secure said base, when said platform is placed in the sea at the latter, to a holding point in the sea (such as a mooring pole embedded in the seabed, for example), so as to constrain the freedom of movement in the sea of said platform.

### BRIEF DESCRIPTION OF THE DRAWINGS

Further objects and advantages of the present invention will become apparent from the following detailed description of exemplary embodiments thereof and from the accompanying drawings, merely given by way of non-limiting explana-tion, in which:

FIG. 1 shows a perspective view of an offshore platform according to the present invention;

FIG. 2 shows a side plan view of the platform in FIG. 1.

### DETAILED DESCRIPTION OF PREFERRED EMBODIMENTS OF THE INVENTION

Hereinafter in the present description, a drawing can also be shown with reference to elements not expressly indicated in that drawing but indicated in other drawings. The scale and proportions of the various elements depicted do not necessarily correspond to the real values.

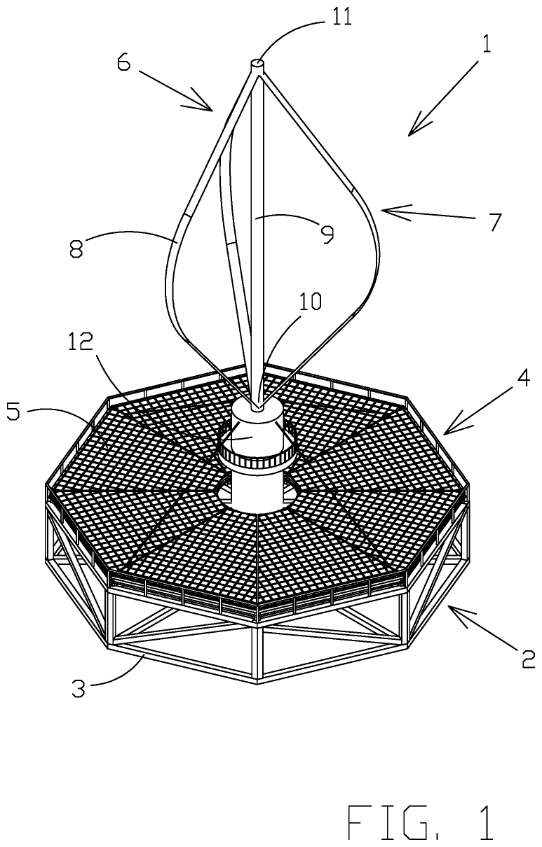

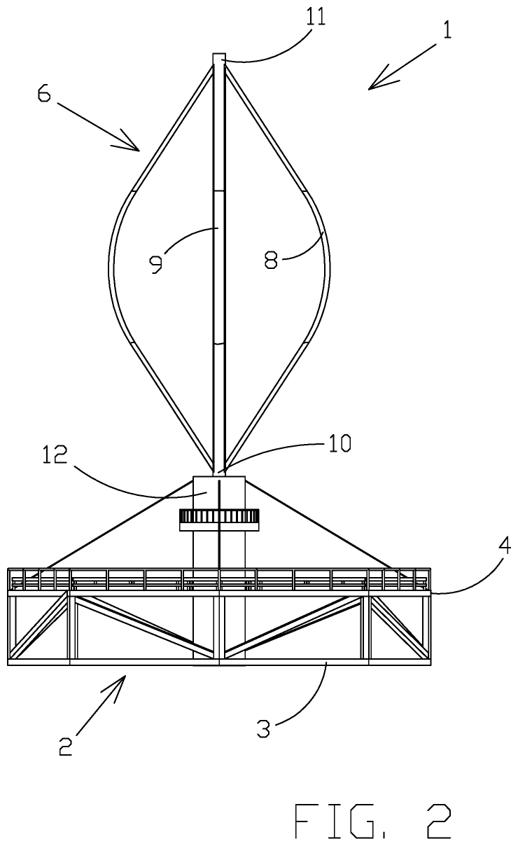

FIGS. 1 and 2 show an offshore platform 1 of the invention comprising a base 2 at which the platform 1 is placeable in the open sea. The base 2 is preferably of a right prismatic shape with a regular octagonal base and preferably comprises a plurality of metal tubular elements 3 with a preferably quadrangular section. The tubular elements 3 are preferably connected to one another at the ends thereof so as to obtain a lattice structure. With reference to the right prism as which the base 2 is preferably and substantially shaped, the distance between the lower and upper bases of the right prism (corresponding to the height of the base 2) is preferably four meters.

The base 2 is preferably floating and is placeable in the sea at the lower base (preferably regular octagonal) of the aforesaid right prism. More preferably, the base 2, when placed in the sea, floats so that an upper wall 4 thereof, corresponding to the upper base of the aforesaid right prism (also preferably regular octagonal), at least partially lies out of the sea. Even more preferably, the base 2 is ballasted so as to be immersed for about three quarters of the height thereof (i.e., preferably for about three meters) when placed in the sea.

The base 2 preferably comprises one or more photovoltaic modules 5. The latter are preferably installed at the wall 4, preferably so as to cover almost the en-tire extension of the latter. Incidentally, as seen in FIG. 1, the modules 5 are installed at the wall 4 so that the “converting surface” of the photovoltaic cells included in the modules 5 faces upwards when the base 2 is placed in the sea. The modules 5 are thus installed at the wall 4 so as to be adapted to convert solar energy into electricity when the base 2 is placed in the sea.

The platform 1 comprises at least one wind turbine 6 of the “vertical axis” type, preferably of the “Darrieus” type. The turbine 6 is supported by the base 2 preferably so that, when the base 2 is placed in the sea (i.e., when the platform 1 is placed in the sea at the base 2), the turbine 6 at least partially and preferably completely lies out of the sea. The turbine 6 includes a rotor 7 which is rotatable about a rotation axis. The turbine 6 is supported by the base 2 preferably so that, when the base 2 is placed in the sea, assuming that the free surface of the sea is flat and arranged horizontally, said rotation axis about which the rotor 7 is rotatable is arranged vertically. The rotor 7 comprises a plurality of blades 8, preferably of the “curved” type, shown by way of example in a number equal to three and integrally connected to a transmission shaft 9. The blades 8 and the shaft 9 are rotatable about the aforesaid rotation axis of the rotor 7. The shaft 9 is preferably parallel to said rotation axis. More preferably, said rotation axis corresponds to the axis of longitudinal symmetry of the shaft 9. The latter comprises a first end 10, shown at the bottom in the Figures, and a second end 11 opposite to the end 10 and shown at the top in the Figures. The shaft 9 is preferably arranged orthogonally to the wall 4, with the end 10 closer to the base 2 with respect to the end 11.

The turbine 6 is adapted to convert at least partially wind energy into a rotation of the rotor 7 about the aforesaid rotation axis, i.e., into a rotation of the blades 8 and of the shaft 9 about the aforesaid rotation axis. Wind turbines with a vertical axis of the Darrieus type are known. Therefore, no further details will be provided.

The platform 1 comprises an alternator 12 connected to the rotor 7 and adapted to convert a rotation of the rotor 7 about the aforesaid rotation axis into electricity. More precisely, the shaft 9 is the one connected to the alternator 12 at the end 10, so that the alternator 12 is adapted to convert a rotation of the shaft 9 about the aforesaid rotation axis into electricity. Since the wind turbines with a vertical axis of the Darrieus type are not self-starting, the platform 1 further comprises an electric motor keyed to the shaft 9 so as to be adapted to set in rotation the latter about the aforesaid rotation axis. Said engine is powerable by the electricity stored in an electric accumulator which is also included in the platform 1. The accumulator is connected to the alternator 12 for storing electricity, in which the alternator 12 is adapted to convert a rotation of said shaft 9 about the aforesaid rotation axis. The accumulator is preferably also connected to the modules 5 for an electricity storage in which the modules 5 are adapted to convert solar energy.

When the turbine 6 is started, the shaft 9 is put into rotation by the aforesaid electric motor, powering the latter through electricity previously stored in the accumulator. Said previously stored electricity can be stored in the accumulator when the latter is installed in the platform 1 or it can be produced by the modules 5. After starting, the accumulator is recharged by the alternator 12 and/or by the modules 5. The latter, alternatively or in addition to being connected to the accumulator, can also be connected “directly” to the electric motor for powering the latter. In other words, the modules 5 are connected to the electric motor directly and/or through the accumulator.

The motor and the accumulator are preferably placed close to the base 2, i.e., in a position such as to be closer to the base 2 of the end 11, and, more preferably, also of the end 10.

The platform 1 comprises an electricity transmission system connected to the accumulator and/or directly to the alternator 12 to transmit the electricity stored in the accumulator out of the platform 1 and/or into which the alternator 12 converts the mechanical energy of the rotor 7. Said transmission system is further connected to the modules 5 to transmit the electricity in which the modules 5 convert solar energy out of the platform 1. In other words, the electricity transmission system is connected to the alternator 12 directly and/or through the accumulator. Similarly, the electricity transmission system is connected to the modules 5 directly and/or through the accumulator.

The platform 1 preferably comprises suitable mooring systems adapted to secure the base 2, when the platform 1 is placed in the sea, to a holding point in the sea (such as a mooring pole embedded in the seabed, for example), so as to constrain the freedom of movement in the sea of the platform 1.

The platform 1 is preferably placeable in a wind farm comprising a plurality of platforms 1 mutually connected by means of multiple electrical cables so that the electricity globally produced by the platforms 1 is transmissible by means of a single submarine cable to a transformer station on land, for example. Based on the description given for a preferred embodiment, it is apparent that some changes can be introduced by those skilled in the art, without however departing from the scope of the invention as defined by the following claims.

1-10. (canceled)

11. An offshore platform comprising:
a base at which said platform is placeable in the sea;
at least one wind turbine supported by said base,
said turbine including a rotor which is rotatable about a rotation axis,
said turbine being adapted to convert at least partially wind energy into a rotation of said rotor about said rotation axis;
at least one alternator connected to said rotor and adapted to convert a rotation of said rotor about said rotation axis into electricity;
electricity transmission means connected to said alternator and adapted to transfer electricity out of said platform, wherein said alternator is adapted to convert a rotation of said rotor about said rotation axis,
when said platform is placed in the sea at said base, said platform being adapted to float so that said turbine lies at least partially out of the sea,
said turbine being of the “vertical axis” type and being supported by said base so that, when said platform is placed in the sea at said base, assuming that the free surface of the sea is flat and arranged horizontally, said rotation axis about which said rotor is rotatable is arranged vertically, said turbine being of the “Darrieus” type,
said rotor comprising a plurality of blades which are connected to a transmission shaft and rotatable, together with said shaft, about said rotation axis,
said turbine being adapted to convert at least partially wind energy into a rotation of said blades and said shaft about said rotation axis,
said shaft including a first end and a second end opposite to said first end,
said turbine being supported by said base so that said first end is closer to said base than said second end,
said shaft being connected to said alternator at said first end,
said shaft being connected to said alternator so that said alternator is adapted to convert a rotation of said shaft about said rotation axis into electricity,
said platform further comprising:
storage means adapted to store electricity,
said storage means being connected to said alternator for storing electricity, wherein said alternator is adapted to convert a rotation of said shaft about said rotation axis;
rotation means connected to said shaft and adapted to rotate the shaft about said rotation axis, said rotation means being electrically powerable,
said storage means being connected to said rotation means for powering the rotation means by means of electricity stored in said storage means,
said base comprising an upper wall,
when said platform is placed in the sea at said base, said platform being adapted to float so that said upper wall lies at least partially out of the sea,
said platform comprising one or more photovoltaic modules at said upper wall, so as to be adapted to convert solar energy into electricity when said platform is placed in the sea at said base,
said transmission means being connected to said one or more photovoltaic modules and being adapted to transfer electricity out of said platform, wherein said one or more photovoltaic modules are adapted to convert solar energy,
wherein said one or more photovoltaic modules are connected to said rotation means for powering the rotation means.

12. The platform according to claim 11, wherein said storage means and said rotation means are closer to said base than said second end.

13. The platform according to claim 11, wherein said storage means are connected to said one or more photovoltaic modules for storing electricity, wherein said one or more photovoltaic modules are adapted to convert solar energy.

14. The platform according to claim 13, wherein said one or more photovoltaic modules are connected to said rotation means only through said storage means.

15. The platform according to claim 11, wherein said transmission means are connected to said storage means and are adapted to transmit the electricity stored in said storage means out of said platform.

16. The platform according to claim 15, wherein said transmission means are connected to said alternator only through said storage means.

17. The platform according to claim 11, further comprising mooring means adapted to secure said base to a holding point in the sea when said platform is placed in the sea at said base.

18. The platform according to claim 14, wherein said transmission means are connected to said storage means and are adapted to transmit the electricity stored in said storage means out of said platform.

19. The platform according to claim 18, wherein said transmission means are connected to said alternator only through said storage means.

20. The platform according to claim 19, further comprising mooring means adapted to secure said base to a holding point in the sea when said platform is placed in the sea at said base.
